(19) United States
(12) Patent Application Publication
(10) Pub. No.: US 2004/0143676 A1
(43) Pub. Date: Jul. 22, 2004

(54) Method of transmitting data in acknowledged mode between a sending unit and a receiving unit, and transmission unit implementing such a method

(75) Inventors: Benjamin Baudry, Meudon (FR); Olivier Isnard, Viroflay (FR)

Correspondence Address: Michael L. Kenaga, PIPER RUDNICK LLP, P.O. Box 64807, Chicago, IL, 60664-0807, US

(73) Assignee: NORTEL NETWORKS LIMITED

(21) Appl. No.: 10/701,827

(22) Filed: Nov. 5, 2003

(30) Foreign Application Priority Data
Nov. 8, 2002 (FR) FR 02 14029

(51) Int. Cl. G06F 15/16

(52) U.S. Cl. 709/237

(57) ABSTRACT

The sending unit (30) produces a sequence of blocks each comprising data to be transmitted and a header, that it sends to a receiving unit (31). The header of each block comprises an acknowledgement control field activated intermittently so as to request an acknowledgement of blocks on the part of the receiving unit. The acknowledgement control field for some blocks of the sequence is activated in accordance with a predetermined triggering mode, and the activation of the acknowledgement control field is repeated for at least one block of the sequence that was sent after a block where the acknowledgement control field has been activated in accordance with the predetermined triggering mode.

The present invention relates to techniques for transmitting data in acknowledged mode from a sending unit to a receiving unit.

The invention relates more particularly, among these techniques, to those in which the sending unit, which produces a sequence of blocks each comprising a header plus user data, uses a “polling” mechanism to request acknowledgements of blocks on the part of the receiving unit. The header of each block then comprises an acknowledgement control field activated intermittently by the sending unit so as to request an acknowledgement of blocks on the part of the receiving unit. In response to such a request, the receiving unit returns a message in which a certain number of previous blocks are acknowledged, positively and/or negatively.

A technique of this kind is used, in particular, in third-generation networks.

Often, the acknowledgement mechanism is used within the context of an automatic repeat request (ARQ) protocol in which the unit sending the blocks waits for a positive acknowledgement before transmitting the subsequent data. Such a protocol may moreover belong to the class of sliding window protocols so as to acquire a process for control of the stream transmitted. The blocks sent are for this purpose furnished with a sequence number, and the sending unit keeps the list of the sequence numbers of the blocks dispatched but not yet acknowledged as well as that of the sequence numbers of blocks that it may dispatch. The lower bound of the window is shifted when a positive acknowledgement of data sent is received by the sending unit, for example so as to indicate the smallest sequence number among those of the blocks not yet acknowledged. If an acknowledgement request message has not been correctly received by the receiving unit, the sliding window of the sending unit may remain blocked at an old position, thereby leading to unnecessary repetitions of blocks already received and to significant delays in the transmission of new data.

To reduce the risk of such a blockage of the sliding window, it is possible to increase the level of protection of the blocks transporting the acknowledgement request messages or else, within these blocks, the information transporting the acknowledgement request, so as to decrease the rate of incorrect reception of these requests. Such a method is described in particular in Patent WO 02/069548.

An object of the present invention is to propose an efficient method for transmitting data in packet mode.

Another object is to reduce the risks of blockage of the send windows used in certain ARQ mechanisms.

The invention thus proposes a method of transmitting data in acknowledged mode between a sending unit and a receiving unit, in which the sending unit sends the receiving unit a sequence of blocks each comprising a header and data to be transmitted. The header of each block comprises an acknowledgement control field activated intermittently by the sending unit so as to request an acknowledgement of blocks on the part of the receiving unit. According to the invention, the acknowledgement control field for some blocks of the sequence is activated in accordance with a predetermined triggering mode, and the activation of the acknowledgement control field is repeated for at least one block of the sequence that was sent after a block where the acknowledgement control field has been activated in accordance with the predetermined triggering mode.

The invention can furthermore be implemented according to a method in which the activation of the acknowledgement control field for blocks of the sequence in accordance with the predetermined triggering mode is performed at regular time intervals. It is also possible to repeat the activation of the acknowledgement control field for N consecutive blocks (N being a number at least equal to 1) of the sequence that are sent just after such a block where the acknowledgement control field has been activated in accordance with the predetermined triggering mode, the N blocks moreover possibly being sent to the receiving unit at regular time intervals.

Moreover, the mode of implementation of the invention can provide for the duration over which these N blocks are sent to be substantially shorter than the time intervals between the sendings of blocks where the acknowledgement control field is activated in accordance with the predetermined triggering mode. Thus, the transmission of an acknowledgement request is protected by a mechanism for repeating this request a limited number of times. The duration over which the repetitions are sent can be tailored in such a way as not to occupy the bandwidth of the system for too long a time with messages for supervising the link.

In one embodiment of the invention, a particular processing of the blocks received having the control field activated is applied by the receiving unit so as to avoid the dispatching of redundant acknowledgement information.

In a first embodiment, the receiving unit is instructed such that after having received a first block of the sequence having the acknowledgement control field activated, it takes no account of the possible activation of the acknowledgement control field for another block of the sequence that was received in a period of predetermined duration after the first block.

Another possibility consists in the receiving unit being instructed such that after having returned acknowledgement information in response to the receipt of a first block of the sequence having the acknowledgement control field activated, it prohibits the dispatching of acknowledgement information in a period of predetermined duration after the first block of the sequence.

Advantageously, provision may moreover be made for this predetermined duration to correspond substantially to N times a time interval separating the sendings of two consecutive blocks of the sequence when one chooses to repeat the activation of the acknowledgement control field for N consecutive blocks (N>1) of the sequence that were sent just after a block where the acknowledgement control field has been activated in accordance with the predetermined triggering mode.

The present invention has moreover as subject a unit for transmitting data in acknowledged mode, comprising means for producing at least one sequence of blocks each comprising data to be transmitted and a header including an acknowledgement control field, means for sending the blocks of the sequence to a receiving unit, and means of intermittent activation of the acknowledgement control field in the header of the blocks of the sequence so as to request an acknowledgement of blocks on the part of the receiving unit. The means of intermittent activation comprise first means for activating the acknowledgement control field for some blocks of the sequence in accordance with a predetermined triggering mode, and second means for repeating the activation of the acknowledgement control field for at least one block of the sequence that was sent after a block where the acknowledgement control field has been activated by the first means.

The said first means may furthermore be arranged so as to activate at regular time intervals the acknowledgement control field for blocks of the sequence. The second means may also advantageously be devised so as to activate the acknowledgement control field of N consecutive blocks of the sequence that were sent just after the block where the acknowledgement control field has been activated by the first means, N being a number at least equal to 1, the N blocks possibly being sent to the receiving unit at regular time intervals when N>1. In the latter case, provision may be made for the duration for which the said N blocks are sent to be substantially shorter than the time intervals between the sendings of blocks where the acknowledgement control field is activated by the first means.

Other features and advantages of the present invention will become apparent in the description below of nonlimiting exemplary embodiments, with reference to the appended drawings, in which:

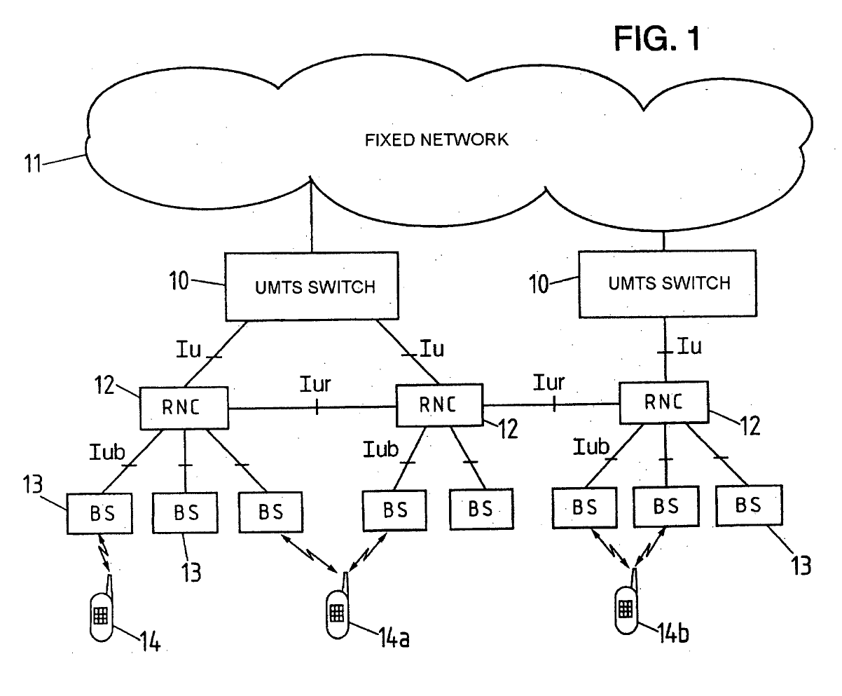

FIG. 1 is a diagram of a UMTS network to which the invention may be applied;

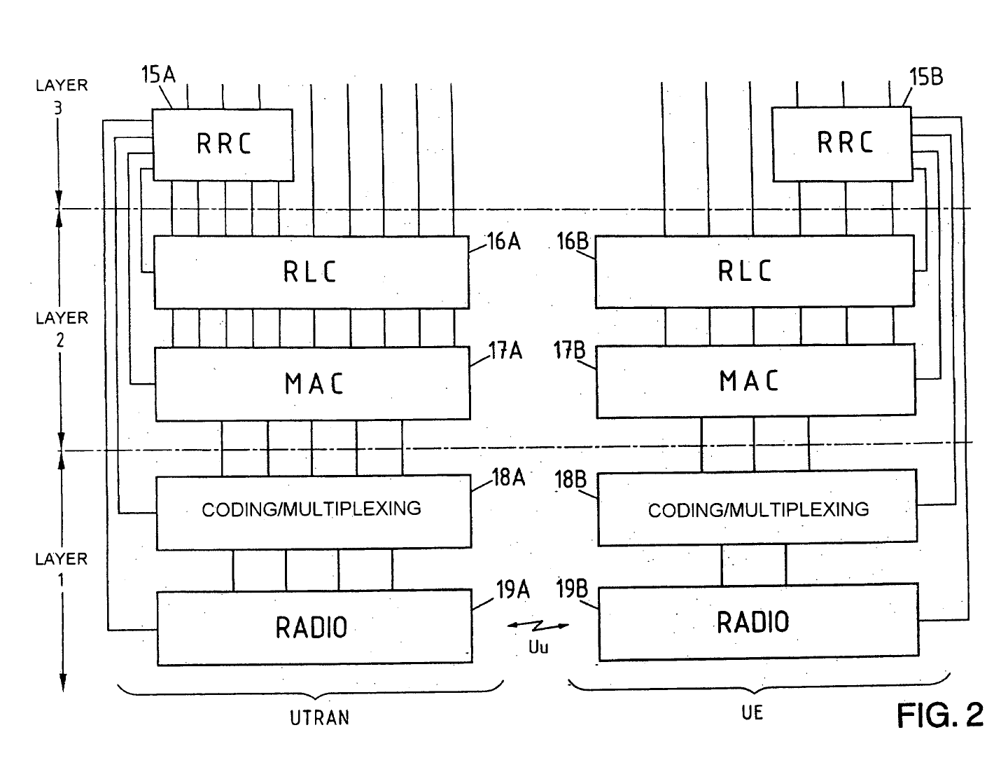

FIG. 2 is a chart showing the organization as layers of communication protocols employed on the radio interface of the UMTS network;

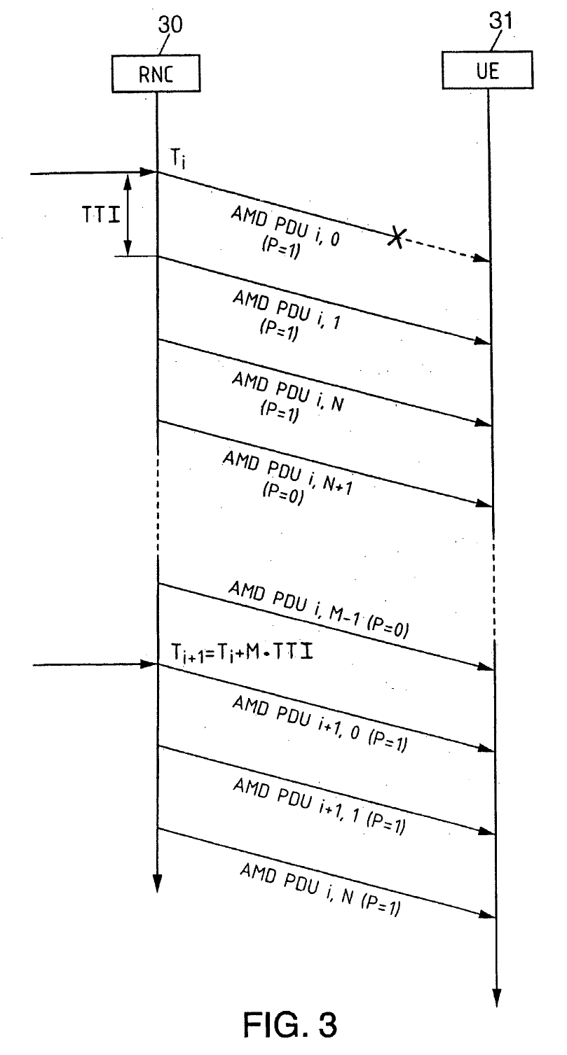

FIG. 3 is a chart of exchanges of protocol units illustrating an implementation of the invention;

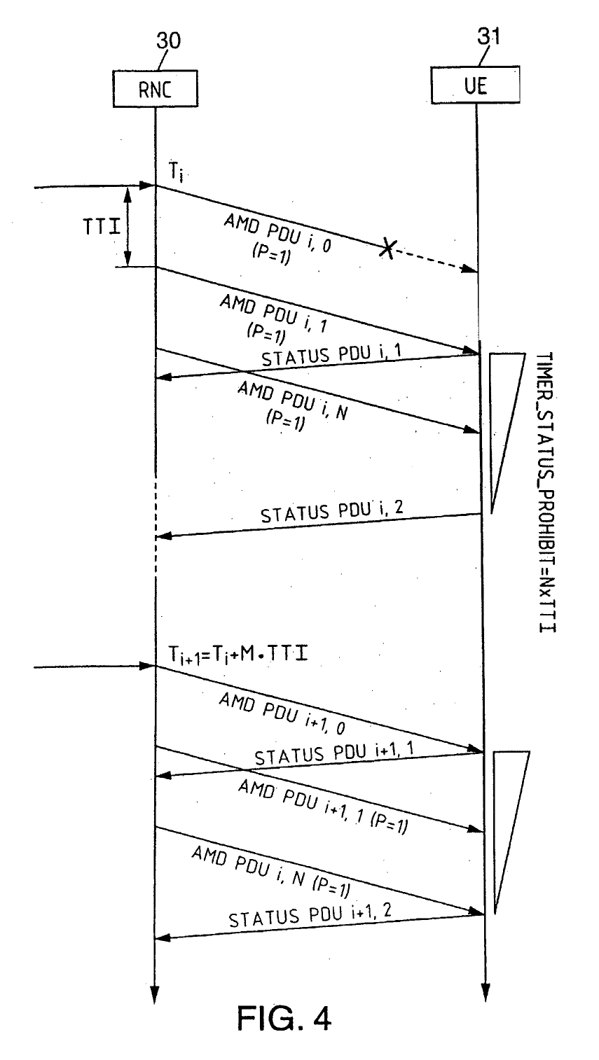

FIG. 4 is a chart of exchanges of protocol units illustrating an implementation of the invention;

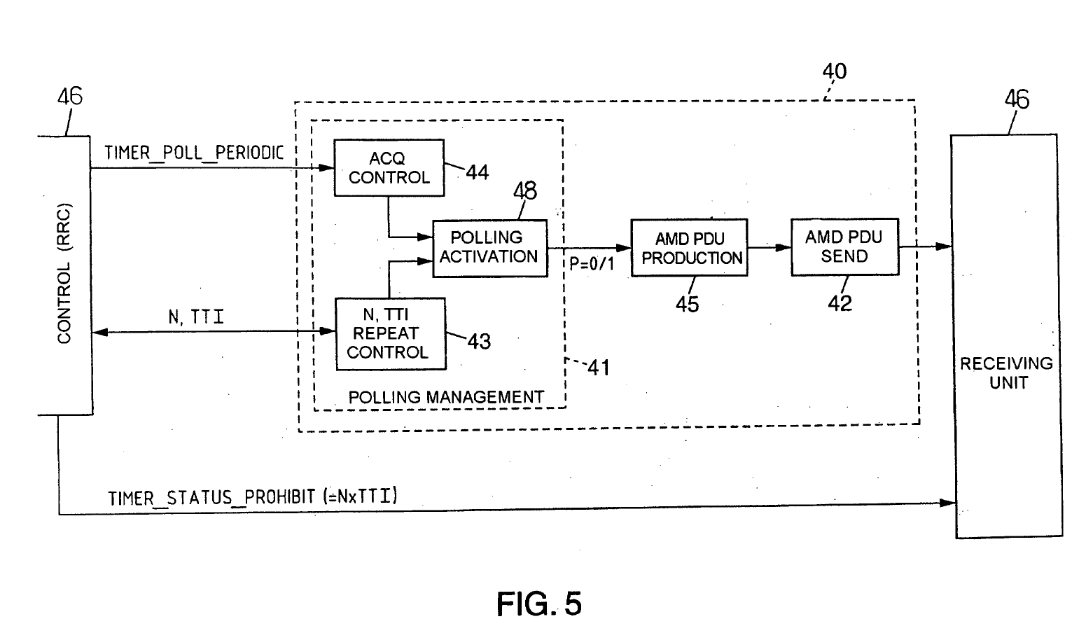

FIG. 5 is a diagram of a data transmission unit according to the invention.

The invention is described below in its application to a UMTS network operating in FDD (frequency division duplex) mode. FIG. 1 shows the architecture of such a UMTS network.

The switches of the mobile service 10, belonging to a core network (CN), are linked on the one hand to one or more fixed networks 11 and on the other hand, by means of a so-called lu interface, to command equipment 12 or RNCs (“Radio Network Controllers”). Each RNC 12 is linked to one or more base stations 13 by means of a so-called lub interface. The base stations 13, distributed over the territory covered by the network, are capable of communicating by radio with the mobile terminals 14, 14a, 14b called UE (“UMTS Equipment”). The base stations can be grouped together to form nodes called “node B”. Certain RNCs 12 may furthermore communicate with one another by means of a so-called lur interface. The RNCs and the base stations form an access network called UTRAN (“UMTS Terrestrial Radio Access Network”).

The UTRAN comprises elements of layers 1 and 2 of the ISO model with a view to providing the links required on the radio interface (called Uu), and a stage 15A for controlling the radio resources (RRC, “Radio Resource Control”) belonging to layer 3, as is described in the 3G TS 25.301 technical specification “Radio Interface Protocol Architecture”, version 3.9.0 published in December 2001 by the 3GPP (3^{rd} Generation Partnership Project). In view of the higher layers, the UTRAN acts simply as a relay between the UE and the CN.

FIG. 2 shows the RRC stages 15A, 15B and the stages of the lower layers which belong to the UTRAN and to a UE. On each side, layer 2 is subdivided into a radio link control (RLC) stage 16A, 16B and a medium access control (MAC) stage 17A, 17B. Layer 1 comprises a coding and multiplexing stage 18A, 18B. A radio stage 19A, 19B caters for the transmission of the radio signals from trains of symbols provided by the stage 18A, 18B, and the reception of the signals in the other direction.

There are various ways of adapting the architecture of protocols according to FIG. 2 to the hardware architecture of the UTRAN according to FIG. 1, and in general various organizations can be adopted depending on the types of channels (see section 11.2 of the 3G TS 25.401 technical specification “UTRAN Overall Description”, version 3.1.0 published in January 2000 by the 3GPP). The RRC, RLC and MAC stages are typically located in the RNC 12. When several RNCs are involved, the MAC sublayer can be apportioned among these RNCs, with appropriate protocols for the exchanges on the lur interface, for example ATM (“Asynchronous Transfer Mode”) and AAL2 (“ATM Adaptation Layer No. 2”). These same protocols may also be employed on the lub interface for the exchanges between the MAC sublayer and layer 1.

Layers 1 and 2 are each controlled by the RRC sublayer, whose characteristics are described in the 3G TS 25.331 technical specification “RRC Protocol Specification”, version 3.1.0 published in October 1999 by the 3GPP. The RRC stage 15A, 15B supervises the radio interface. Moreover, it processes streams to be transmitted to the remote station according to a “control plan”, as opposed to the “user plan” which corresponds to the processing of the user data arising from layer 3.

The RLC sublayer is described in the 3G TS 25.322 technical specification “RLC Protocol Specification”, version 3.9.0 published in December 2001 by the 3GPP. In the send direction, the RLC stage 16A, 16B receives, according to the respective logical channels, data streams consisting of service data units (RLC-SDU) arising from layer 3. An RLC module of the stage 16A, 16B is associated with each logical channel so as in particular to perform a segmentation of the RLC-SDU units of the stream into blocks, or protocol data units (PDU, “Packet Data Units”) addressed to the MAC sublayer and comprising an RLC header. In the receive direction, an RLC module conversely performs a reassembling of the RLC-SDU units of the logical channel from the blocks received from the MAC sublayer.

According to the logical channels and under the control of the RRC stage, the RLC sublayer can render a transfer service in transparent mode, in acknowledged mode or in nonacknowledged mode. An acknowledgement mechanism based on sequence numbers of the blocks sent is provided for in acknowledged mode. Two types of protocol unit blocks of the RLC sublayer are distinguished: the information transfer blocks (“data PDUs”) and, for the acknowledged mode only, the control blocks (“control PDUs”). Among the latter, the “STATUS” control block allows in particular the receiving entity to indicate to the sending entity the information transfer blocks that have been correctly received and those that have been lost during transmission.

The receiving entity in fact sends on request or spontaneously supervision reports (“status reports”) to the sending unit that consist of one or more “STATUS” control blocks. An acknowledgement control function makes it possible to instruct the triggering of the activation of an acknowledgement request according to one or more predetermined modes. The standard currently makes provision for several activation modes, each being defined by a particular triggering condition. The triggering condition may for example consist of the expiry of a supervision report requests periodicity timer (“Timer_Poll_Periodic”), in such a way as to trigger the periodic dispatching to the receiving unit of a report request.

Each acknowledged-mode information transfer block (“AMD PDU”) comprises a header field and a field of data to be transmitted. The header of each block comprises an acknowledgement control field, consisting of a bit termed the polling bit, which may be activated to request a report of reception of blocks on the part of the RLC sublayer of the receiving unit. The request is thus sent by setting this polling bit to 1.

The MAC sublayer is described in the 3G TS 25.321 technical specification. “MAC Protocol Specification”, version 3.1.0 published in October 1999 by the 3GPP. It transposes one or more logical channels onto one or more transport channels TrCH. In the send direction, the MAC stage 17A, 17B can multiplex one or more logical channels in one and the same transport channel. On such a transport channel, the MAC stage 17A, 17B delivers successive transport blocks TrBk each consisting of an optional MAC header and an RLC-PDU unit arising from an associated logical channel.

For each TrCH, the RRC sublayer provides the MAC sublayer with a set of transport formats (TFS, “Transport Format Set”). A transport format comprises a transmission time interval TTI equal to 10, 20, 40 or 80 ms, a transport block size, a transport block set size and parameters defining the protection scheme to be applied in the TrCH by layer 1 for detecting and correcting transmission errors. Depending on the current bit rate on the logical channel or channels associated with the TrCH, the MAC stage 17A, 17B selects a transport format from the TFS assigned by the RRC sublayer, and it delivers in each TTI a set of transport blocks complying with the selected format, whilst indicating this format to layer 1.

The acknowledged-mode information transfer blocks AMD PDU are numbered by an integer sequence number, denoted SN (“Sequence Number”). The RLC entity of the sending unit keeps an updated set of state variables, including:

an acknowledged state variable VT(A) that indicates the sequence number which immediately follows the sequence number of the last acknowledged AMD PDU block. The variable VT(A) thus points to the current lower bound of a send window. The updating thereof is performed on receipt of an acknowledgement;

a send window size state variable VT(WS) (“Transmission Window state variable”);

a send state variable VT(MS) (“Maximum Send state variable”), the value of which represents the upper bound of the send window and is determined according to the relation VT(MS)=VT(A)+VT(WS).

The send window makes it possible to control the sending of blocks of a sequence whose previous blocks have not yet been acknowledged by the receiving unit. In most cases, the RLC send entity will prohibit itself from transmitting blocks, whose sequence number exceeds the current value VT(MS). The acknowledged state variable being updated on receipt of the acknowledgement of a block of specified sequence number, the loss of one or more supervision report requests may lead to the blockage of the send window, even though the corresponding data have been correctly received by the receiving unit without it being possible for their acknowledgement to be sent in the absence of a supervision report request.

According to a preferred mode of embodiment of the invention, it is proposed that at least one repeat of the report request generated in response to the realization of a condition of triggering of the acknowledgement control function be transmitted to the receiving unit in addition to this request. These request repeats, when they are multiple, are transmitted at a substantially higher tempo than that of the requests generated in response to the realization of a condition of triggering of the acknowledgement control function. In a UMTS system, the transmission of the multiple repeats is preferably performed at regular intervals, typically corresponding to a TTI interval. The transmission of the request repeats on successive blocks within one and the same TTI interval would in fact probably limit the efficiency thereof. The simple presence of fading on the transmission channel would give rise not only to the loss of the block transporting the request, but also that of the succeeding blocks and hence of the request repeats.

FIG. 3 illustrates a mechanism according to the invention between the RLC entities of a sending unit 30 and of a receiving unit 31. The sending unit may be that of an RNC controller in the case of UMTS, and the receiving unit that of a UE. The time axis relating to the sending unit 30 is divided according to an interval, regular in the example illustrated, which may correspond to a TTI transmission interval. The condition of triggering of the acknowledgement control function of the sending unit 30 is configured in such a way that the triggering of the function takes place at an instant Tᵢ₊₁=Tᵢ+M×TTI spaced M×TTI from the previous triggering that occurred at the instant Tᵢ. At the instant Tᵢ a supervision report request is therefore sent to the receiving unit (AMD PDU block i,0, bit P of which is set to 1). FIG. 3 illustrates the case where this request is not received by the receiving unit, and does not therefore give rise to the dispatching of a supervision report by the receiving unit. According to the invention, N (in the example, N=2<M) repeats of the request of the block AMD PDU i,0 (blocks AMD PDU, i,1 and i,N) are sent, so as to alleviate the possible loss of the block AMD PDU i,0, or of the N−1 blocks AMD PDU i,1 . . . N−1. These repeats are sent at the tempo of one per TTI interval. Blocks AMD PDU, i,N+1 to AMD PDU i,M−1 sent at the instants Tᵢ+(N+1)×TTI to Tᵢ+(M−1)×TTI have for their part a polling bit set to zero (P=0). FIG. 3 thus illustrates the sending of AMD PDU blocks i,j at each TTI interval, the index i corresponding to the time interval between the instants Tᵢ and T_{i+(M-}1)×TTI during which M blocks are sent, and the index j illustrating the values taken by a counter of these M blocks reset to zero with each block sent following the triggering of the acknowledgement control function.

At the instant Tᵢ₊₁, the triggering of the acknowledgement control function occurs thereby generating the dispatching of a new request to the receiving unit (AMD PDU block i+1,0). This request is also repeated N times (the polling bit of the AMD PDU blocks i+1,1 . . . N is set to 1).

FIG. 3 illustrates moreover the fact that M is preferably chosen in such a way as to be substantially greater than N. The choice of the ratio N/M results from a compromise aimed at effectively limiting the risk of window blockage while avoiding the dispatching of too large a quantity of repeats.

FIG. 4 illustrates a further mode of embodiment of the invention, in which the use of a report prohibit timer makes it possible to prevent the dispatching of a supervision report for each of the request repeats. The report prohibit timer (“Timer_Status_Prohibit”) makes it possible to prohibit the dispatching of one or more consecutive supervision reports by the receiving unit. This timer is set upon the dispatching of the supervision report responding to the first request received by the receiving unit, whether this be the request triggered by the acknowledgement control function or one of the N repeats of this request. Preferably, this timer is set with a value equal to or greater than N×TTI so as to cover the maximum duration for which request repeats are liable to be received by the receiving unit. A single supervision report (STATUS PDU, i,2) is generated on the expiry of the timer, however many requests are received while it is running. In this way, a first supervision report (STATUS PDU i,1) is dispatched in response to the receipt of the first request received, then a second report (STATUS PDU i,2) is dispatched on expiry of the prohibit timer. The possible loss of one of these two reports may thus advantageously be compensated for.

A timer making it possible to completely ignore the requests received could equally well be used, without thereby modifying the nature of the present invention. Just as before, this timer would advantageously be set with a value equal to or greater than N×TTI upon the dispatching of the supervision report responding to the first request received by the receiving unit, whether this be the request triggered by the acknowledgement control function or one of the N repeats of this request.

FIG. 5 illustrates certain means of the sending unit (40) according to the invention. These means pertain to the instance of the acknowledged-mode RLC protocol created at the RNC (case of a downlink) or at the UE (case of an uplink) to support the transfer of the AMD PDU blocks.

The sending unit comprises a module (41) for managing report requests (polling) which will control the setting of the polling bit within the AMD PDU blocks produced by the production module (45) with a view to being sent by the module (42) to the RLC protocol instance created at the level of the receiving unit (47). The module (41) comprises a first module (44) for activating the polling bit upon triggering, for example periodic according to the Timer_Poll_Periodic parameter, of the acknowledgement control function (“polling trigger”).

Send parameters for the request repeats are held in a second module (43) for activating the polling bit so as to repeat acknowledgement requests. These parameters comprise, for example, the number N of repeats and their pace (1 repeat per TTI interval). They can be communicated to the RLC protocol instance by the RRC layer, by means of an RRC control module (46) which configures the module (43).

The aforesaid parameters could also advantageously be held in a database of for example MIB type (“Management Information Base”—see in particular RFC recommendation 2737 of the Internet Engineering Task Force, published in December 1999), and be updated by way of an operation and maintenance system (O&M).

The modules (43) and (44) will drive a module (48) for activating the polling bit in the header of the blocks sent. This module (48) indicates the value of the polling bit to the module (45). It activates the polling bit (P=1) for each repetition in accordance with the parameters held in the module (43), and according to each activation requested by the module (44).

For the implementation of the method illustrated in FIG. 4, the transmission unit comprises, in one embodiment of the invention, means (46) for activating the use of the report prohibit timer (“Timer_Status_Prohibit”) by the receiving unit (47). The procedures of the RRC protocol comprise procedures for managing radio resources described in Section 8.2 of the aforesaid technical specification 3G TS 25.331. The configuration of this timer is thus driven by the RRC layer (module 46), by means of configuration messages (“RADIO BEARER SETUP” or “RADIO BEARER RECONFIGURATION” messages) which make it possible to transmit this timer's setting value to the receiving unit (“RLC Info” and “Downlink RLC Status Info” information units described in paragraphs 8.6.4.9, 10.3.4.23 and 10.3.4.1, respectively).

In an alternative embodiment of the invention, the control module (46) for the RRC layer instructs the receiving unit such that it takes no account of supervision report requests received over a predetermined duration following the dispatching of the report responding to a first request received.

The triggering of the acknowledgement control function is instructed by the RRC layer, by way of the “CRLC-Config-Req” primitive, described in paragraphs 8.1 and 8.2 of the aforesaid 3G TS 25.322 specification, as well as in paragraph 5.1.1 of the aforesaid 3G TS 25.301 technical specification. In particular, the value of the periodic triggering timer “Timer_Poll_Periodic” may if appropriate be defined in this way, as illustrated in FIG. 5.

The TS 25.322 technical specification allows the sending of AMD PDU blocks that do not contain data to be transmitted. The data field of such blocks contains padding bits. The module (45) produces AMD PDU blocks from the supervision information to be transmitted (including the information for activating if appropriate the polling bit) and from data to be transmitted. In situations where there is no longer any data to be transmitted, but where the module (43) instructs the dispatching of an acknowledgement request repeat, the module (45) can admittedly generate an AMD PDU block whose polling bit is set to 1 and which contains no data to be transmitted. It can however advantageously also generate an AMD PDU block whose polling bit is set to 1 and whose data field reproduces that of the last AMD PDU block sent containing data to be transmitted (preferably not having already been acknowledged), or else simply ignore the polling bit activation instructed by the module (43).

1. Method of transmitting data in acknowledged mode between a sending unit and a receiving unit, in which the sending unit sends the receiving unit a sequence of blocks each comprising a header and data to be transmitted, and in which the header of each block comprises an acknowledgement control field activated intermittently by the sending unit so as to request an acknowledgement of blocks on the part of the receiving unit, the method comprising the following steps:
/a/ the acknowledgement control field for some blocks of the sequence is activated in accordance with a predetermined triggering mode; and
/b/ the activation of the acknowledgement control field is repeated for at least one block of the sequence that was sent after a block where the acknowledgement control field has been activated in step /a/.

2. Method according to claim 1, in which step /a/ comprises the activation at regular time intervals of the acknowledgement control field for blocks of the sequence.

3. Method according to claim 1 or 2, in which step /b/ comprises the repetition of the activation of the acknowledgement control field for N consecutive blocks of the sequence that were sent just after the said block where the acknowledgement control field has been activated in step /a/, N being a number at least equal to 1.

4. Method according to claim 3, in which N>1 and the said N blocks are sent to the receiving unit at regular time intervals.

5. Method according to claim 4, in which the duration for which the said N blocks are sent is substantially shorter than the time intervals between the sendings of blocks where the acknowledgement control field is activated in step /a/.

6. Method according to any one of the preceding claims, in which the receiving unit is instructed such that after having received a first block of the sequence having the acknowledgement control field activated, it takes no account of the possible activation of the acknowledgement control field for another block of the sequence that was received in a period of predetermined duration after the said first block.

7. Method according to each one of claims 3 and 6, in which the said predetermined duration corresponds substantially to N times a time interval separating the sendings of two consecutive blocks of the sequence.

8. Method according to any one of claims 1 to 5, in which the receiving unit is instructed such that after having returned acknowledgement information in response to the receipt of a first block of the sequence having the acknowledgement control field activated, it prohibits the dispatching of acknowledgement information in a period of predetermined duration after the said first block of the sequence.

9. Method according to each one of claims 3 and 8, in which the said predetermined duration corresponds substantially to N times a time interval separating the sendings of two consecutive blocks of the sequence.

10. Unit for transmitting data in acknowledged mode, comprising means (45) for producing at least one sequence of blocks each comprising data to be transmitted and a header including an acknowledgement control field, means (42) for sending the blocks of the sequence to a receiving unit, and means (41) of intermittent activation of the acknowledgement control field in the header of the blocks of the sequence so as to request an acknowledgement of blocks on the part of the receiving unit, in which the means of intermittent activation comprise first means (44, 48) for activating the acknowledgement control field for some blocks of the sequence in accordance with a predetermined triggering mode, and second means (43, 48) for repeating the activation of the acknowledgement control field for at least one block of the sequence that was sent after a block where the acknowledgement control field has been activated by the said first means (44, 48).

11. Unit according to claim 10, in which the said first means (44) are arranged so as to activate at regular time intervals the acknowledgement control field for blocks of the sequence.

12. Unit according to claim 10 or 11, in which the said second means (43) are arranged so as to activate the acknowledgement control field of N consecutive blocks of the sequence that were sent just after the said block where the acknowledgement control field has been activated by the said first means (44), N being a number at least equal to 1.

13. Unit according to claim 12, in which N>1 and the said N blocks are sent to the receiving unit at regular time intervals.

14. Unit according to claim 13, in which the duration for which the said N blocks are sent is substantially shorter than the time intervals between the sendings of blocks where the acknowledgement control field is activated by the said first means (44).

15. Unit according to any one of claims 10 to 14, furthermore comprising means for instructing the receiving unit in such a way that after having received a first block of the sequence having the acknowledgement control field activated, the receiving unit takes no account of the possible activation of the acknowledgement control field for another block of the sequence that was received in a period of predetermined duration after the said first block.

16. Unit according to each one of claims 12 and 15, in which the said predetermined duration corresponds substantially to N times a time interval separating the sendings of two consecutive blocks of the sequence.

17. Unit according to any one of claims 10 to 14, furthermore comprising means (46) for instructing the receiving unit in such a way that after having returned acknowledgement information in response to the receipt of a first block of the sequence having the acknowledgement control field activated, it prohibits the dispatching of acknowledgement information in a period of predetermined duration after the said first block.

18. Unit according to each one of claims 12 and 17, in which the said predetermined duration corresponds substantially to N times a time interval separating the sendings of two consecutive blocks of the sequence.
